(19) United States
(12) Patent Application Publication
(10) Pub. No.: US 2005/0280807 A1
(43) Pub. Date: Dec. 22, 2005

(54) Method and system for inspecting a wafer

(75) Inventors: Henning Backhauss, Wetzlar (DE); Albert Kreh, Solms (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Semiconductor GmbH, Wetzlar (DE)

(21) Appl. No.: 11/153,294

(22) Filed: Jun. 15, 2005

(30) Foreign Application Priority Data
Jun. 16, 2004 (DE) 10 2004 029 012.1

(51) Int. Cl. G01N 21/88

(52) U.S. Cl. 356/237.2

(57) ABSTRACT

A method for inspecting a wafer includes acquiring, prior to an application of a layer onto the wafer, a first optical image of a region of the wafer surface to be inspected. After at least partial removal of the layer, a second optical image is acquired. The region of the wafer surface is inspected by comparing the first and the second images.

### CROSS REFERENCE TO RELATED APPLICATIONS

Priority is claimed to German patent application 10 2004 029 012.1, the entire disclosure of which is hereby incorporated by reference herein.

### FIELD OF THE INVENTION

The invention concerns a method for inspecting a wafer, in particular for examining edge bead removal, an optical image of the region to be inspected being acquired. The invention further concerns a corresponding system having an optical detector for acquiring an optical image of the region to be inspected. Lastly, the invention concerns a computer program and a computer program product for implementing the inspection method.

### BACKGROUND OF THE INVENTION

In semiconductor production, wafers are coated with layers such as photoresist and often also anti-reflection layers. This is generally done by applying a predetermined amount of the substance to be applied onto the rotating wafer disk, on which the substance becomes uniformly distributed. With this method, slightly more substance (photoresist) becomes deposited in the edge region of the wafer than in the middle of the wafer. An “edge bead” is thereby formed. An edge bead of this kind can result, in later wafer processing steps, in detachment of portions of the edge bead and thus in contamination of production machinery, and in the creation of defects on the wafer.

To eliminate these effects, an edge bead removal (EBR) is performed. Edge bead removal can be accomplished in wet-chemical and/or optical fashion. For wet-chemical removal, a suitable solvent is sprayed onto the edge of the wafer; for optical edge bead removal, the edge is exposed in controlled fashion and the exposed region is subsequently removed in the development process.

Edge bead removal defects can result from inaccurate alignment of the corresponding bead removal apparatuses relative to the wafer. Further defect sources include inaccurate alignment of the illumination device relative to the wafer during exposure of the photoresist. Edge bead removal defects can cause the bead-removed wafer edge to be too narrow or too wide, or result in an eccentric profile of that edge. Insufficient edge bead removal can result in contamination during subsequent wafer processing; excessive edge bead removal, on the other hand, can cause an increase in wastage due to a decrease in the usable wafer area. In both cases, the productivity of the production process is reduced. It is therefore necessary to be able to draw conclusions as to the edge bead removal width. It is of interest to inspect this after each wafer production step, i.e. after each application of a photoresist layer with subsequent edge bead removal.

DE 102 32 781 A1 refers to a known device by means of which a wafer is illuminated in bright-field fashion and scanned with a camera. The images obtained are then examined via image processing in order to make the edge bead removal visible. It becomes apparent in this context that depending on the process step, the acquired images show a wide variety of edges, deriving from various process steps, on the wafer surface in the edge region of the wafer. The edges differ from one another in terms of color or grayscale, partially intersect and overlap one another, and in some cases also modify the profile of the color or grayscale value. It has therefore hitherto been considered difficult or even impossible to detect edge bead removal automatically using this kind of image processing.

DE 102 32 781 A1 therefore proposes a system comprising an incident illumination source and an imaging device for inspection of a wafer surface, the illumination device being rotated through a suitable angle out of the bright-field illumination setting, in such a way that an observation of the wafer surface in dark-field mode occurs. This allows particularly effective inspection of, for the most part, small structures that are characterized by a small elevation difference as compared with the background.

A disadvantage that has emerged in the context of this inspection method, however, is that here again a clearly delimited edge often is not visible, and edges from previous process steps greatly reduce the detectability of the edge bead removal.

### SUMMARY OF THE INVENTION

It is therefore an object of the present invention to provide a method and a system for inspecting a wafer, in particular for examining edge bead removal, in which context an optical image of the region to be inspected is to be acquired by means of an optical detector, and the structures being examined are to become clearly evident.

According to the present invention, a first optical image is acquired prior to the application of a layer onto the wafer, and a second optical image after the at least partial removal of that layer; and that the imaged region of the wafer surface is inspected by comparing the first and the second image. The layer to be applied is usually, in practice, a photoresist layer (resulting from application of photoresist material) or an antireflection layer. Without limitation as to generality, the discussion below will refer predominantly to a photoresist layer on which the aforementioned edge bead removal is performed. The invention is also valid, however, for layers of other kinds that are at least partially removed, such as anti-reflection layers.

The comparison according to the present invention between the first and the second image makes it possible to eliminate features of previous processes. As a result, structures that derive from previous process steps can no longer have an interfering effect. The comparison of the two images is performed by suitable image processing, which works out the difference between the images. This can be done in simple fashion, for example, by creating a difference image.

Taking the example of the photoresist layer with subsequent edge bead removal, in the method according to the present invention the first optical image is acquired before application of the photoresist layer (i.e. before application of the resist droplet onto the rotating wafer). This image then shows the actual state of the wafer surface resulting from the previous process steps. Depending on the type of edge bead removal (wet-chemical and/or optical), the second optical image is acquired either immediately after edge bead removal or only after development of the photoresist layer. In the latter case, the second image shows the relief resulting from development of the photoresist, including edge bead removal. The structures present in the first image are also (at least partially) visible in the second image. A comparison of the two images thus allows these structures remaining behind from the previous process steps to be eliminated. In the simplest case, a difference image is created for this purpose, but weighted differentiation or other known image processing methods can also be performed in order to make the differences between the two images maximally recognizable.

It has been found that with the method according to the present invention, the edge bead removal, i.e. the distance from the wafer edge over which material has been removed, can be determined better than previously. From a comparison of the two images, the edge width and possibly further variables of interest, such as tolerance, eccentricity, etc., can be quickly determined by image processing. It is useful to store only the resulting image (for example, the difference image) or, in order to reduce data volume even further, only the specific resulting values. In problem cases that are difficult to evaluate, provision can also be made, for example, to store both images in order to enable later visual re-examination.

The method according to the present invention can operate with the known illumination modes, in which context the optical images can be acquired in bright-field mode, dark-field mode, or combined bright- and dark-field mode.

The region to be inspected can be scanned by an optical detector (linear or matrix detector). One-shots (imaging of the entire wafer in one image) are also useful. The optical resolution in this context must be adapted to the desired resolution of the regions to be detected (edge bead removal width).

In the case of edge bead removal inspection, a linear camera (e.g. CCD or CMOS), which acquires images of the edge region of the wafer that is rotating beneath the linear camera, proves advantageous. The image frequency of the linear camera and the rotation frequency of the wafer must be suitably coordinated with one another. With an arrangement of this kind, the edge bead removal width tolerance that must be complied with can be determined with sufficient resolution.

Various combinations of illumination and detection modes are suitable for the method according to the present invention. The region to be inspected (or even the entire wafer) can be illuminated monochromatically or polychromatically. The optical detector can constitute a monochrome or color camera. In this context, polychromatic illumination does not necessarily require a color camera; instead, a monochrome camera that is spectrally sensitive at least to a region of the polychromatic illumination can also be used. In general, it is possible to work with incident bright-field illumination.

Because the number of structures imaged with incident dark-field illumination is small as compared with the corresponding bright-field illumination, the use of such illumination must be carefully considered. In suitable cases, only the structures to be examined remain visible after evaluation of the images. A bright-field illumination could additionally be supplemented with a dark-field illumination in order to emphasize particular properties.

Components of an apparatus described in DE 102 32 781 A1 are usable, in principle, for the method according to the present invention. Reference is explicitly made to the aforesaid Unexamined Application regarding the properties and mode of operation of such an apparatus.

According to the present invention, a wafer inspection system for inspecting a wafer, in particular for examining edge bead removal, is equipped with an optical detector for acquiring an optical image of the region to be inspected, and with a data readout device for reading out the image data furnished by the optical detector, having a computer unit connected to the data readout device for comparing acquired images of the region to be inspected. It is sufficient and advantageous if the system comprises a single optical detector that acquires a first image prior to application of a layer onto the wafer, and a second image after at least partial removal of that layer. The computer unit compares the acquired images and thus makes possible inspection according to the present invention of the imaged region of the wafer surface.

The use of a single optical detector ensures that the first and the second image can be acquired without calibration problems. The system according to the present invention can usefully be integrated into the wafer manufacturing process, so that the processed wafer passes through the inspection system once prior to application of, for example, the photoresist layer, and then, for example, after development of the photoresist.

The computer unit advantageously undertakes not only comparison of the image data, but at the same time determination of measurement variables of interest, such as edge width, tolerance, etc.

A computer program having program code means is advantageously executable in the aforesaid computer unit of the inspection system in order to perform the inspection method according to the present invention. The computer program advantageously comprises for that purpose an image processing module that works out the difference between two optical images in a manner optimal for the present wafer inspection process. The computer program furthermore comprises means, such as a pattern recognition module, for extracting the data of interest from the resulting comparison or difference image. In the case of edge bead removal inspection, the data to be extracted include the width of the edge, the average deviation thereof (tolerance), the eccentricity of the bead-removed edge on the round wafer, etc. The data that are ascertained can be stored in suitable form; it may be useful, in the event that tolerances that are to be complied with are exceeded, if appropriate warning signals or notifications thereof are issued.

The computer program can be stored on suitable data media, such as EEPROMs or flash memories, but also CD-ROMs, diskettes, or hard drives. Downloading of the computer program via internal or publicly usable networks is also possible and known.

### BRIEF DESCRIPTION OF THE DRAWINGS

The invention will be explained below in more detail with reference to exemplifying embodiments depicted in the drawings.

FIG. 1 shows a three-dimensional arrangement of a system for inspecting a wafer in the region of the wafer edge, in particular for edge bead removal inspection.

FIG. 2 schematically shows two optical images (FIGS. 2A and 2B) such as can be acquired, for example, using a matrix camera in a system as shown in FIG. 1, as well as a comparison image (FIG. 2C).

FIG. 3 schematically shows two optical images 25 and 26 such as can be acquired, for example, using a linear camera in a system as shown in FIG. 1, as well as a comparison image 27.

FIG. 4 shows a three-dimensional arrangement of a wafer inspection system having two illumination devices 13 and 14 for observation respectively in bright-field and dark-field mode.

FIG. 5 shows a slightly modified embodiment of the system of FIG. 4, having a different type of dark-field illumination device 14.

FIG. 6 shows a different view of a system according to FIG. 5, having a slightly modified arrangement of bright-field illumination device 13.

FIG. 7 shows the system according to FIG. 1 having two illumination devices 13 and 14 for dark-field and bright-field observation, respectively.

### DETAILED DESCRIPTION OF THE INVENTION

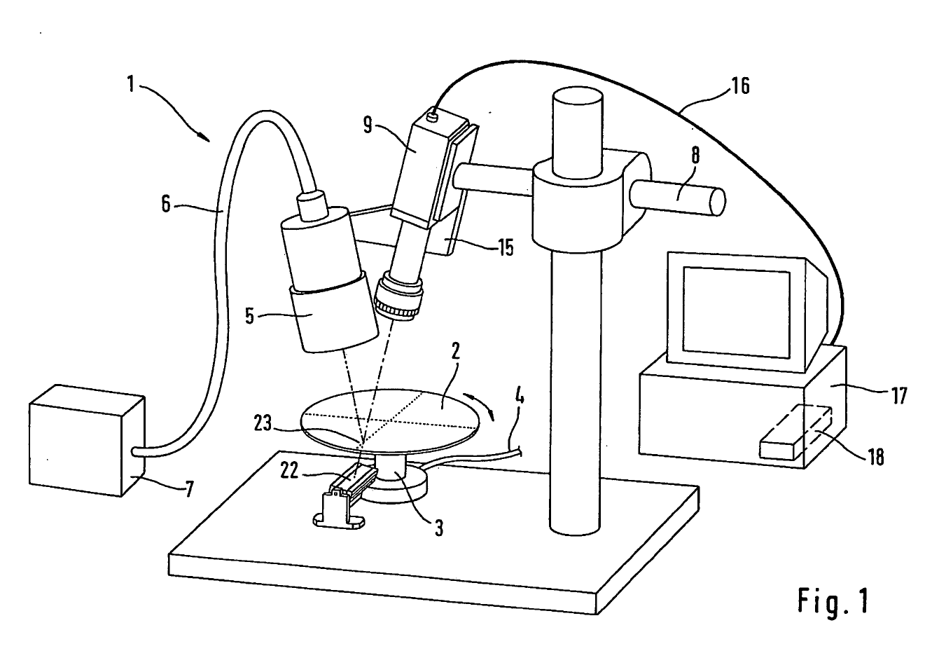

FIG. 1 shows a system for wafer inspection, in particular for examining edge bead removal, that is suitable for the present invention. An optical detector 9, in this case an imaging device in the form of a CCD linear camera, and an incident illumination device 5 are directed onto a region to be inspected of wafer 2 in the region of its wafer edge 23. The overall system for wafer inspection is labeled 1. A wafer edge position detection device 22 is provided for alignment of the wafer, an alignment being performed by means of illumination beneath wafer 2. The image data acquired by imaging device 9 are transferred via a data line 16 to a data readout device 17. This data readout device 17 is or contains a computer unit 18 for evaluating acquired images.

System 1 depicted here makes possible incident illumination in both bright- and dark-field modes. For that purpose, incident illumination device 5 is directed onto the region to be inspected of wafer edge 23 of wafer 2. Light travels via a light source 7 and a light-guiding bundle 6 into illumination device 5, which is arranged at an inclination with respect to the surface of wafer 2. Imaging device 9 is arranged on a displaceable support element 8 by means of a support rail 15. The axes of imaging device 9 and illumination device 5 are drawn with dashed lines, and intersect at the surface of wafer edge 23.

If an inspection of the wafer edge in bright-field mode is to occur, illumination device 5 is then arranged with respect to imaging device 9 in such a way that the axes (drawn with dashed lines) of the two devices 9 and 5 lie, at the intersection of the two axes, in a common plane with the wafer normal line that is perpendicular to the surface of wafer 2.

On the other hand, a dark-field observation can also be performed with system 1 by rotating illumination device 5 out of the aforementioned plane through an angle, so that the axis of illumination device 5 no longer lies in the plane spanned by the aforesaid wafer normal line and the axis of imaging device 9.

Lastly, a combined bright- and dark-field observation is also possible with system 1 depicted here, for example by the fact that a bright-field observation is performed with illumination device 5, and one or more additional illumination devices are provided for additional dark-field observation.

In inspection system 1 depicted here, wafer 2 rests on a receiving device 3 that retains wafer 2 by vacuum suction. The necessary vacuum is conveyed to receiving device 3 via a vacuum line 4.

Some aspects of the system depicted here in FIG. 1 are described in the previously cited document DE 102 32 781 A1. Reference is explicitly made to this document regarding the possibility, in particular, of dark-field observation using the system depicted.

By appropriate selection of the angles of the axes of illumination device 5 and imaging device 9 with respect to the wafer normal line, and optionally by adjusting a dark-field angle, the user can adapt the bright-field and dark-field illumination to the property that is to be inspected, so that the structure to be examined can be optimally imaged.

It should be mentioned that other illumination and imaging axes can also be implemented with the system according to FIG. 1. In principle, the respective axes must be selected in such a way that optimum image contrast levels are obtained for purposes of the inspection method according to the present invention.

It is useful to integrate system 1 depicted here into the production process of wafer 2. According to the present invention, wafer 2 passes through inspection system 1 twice for each processing cycle. The (possibly pre-processed) wafer is brought into inspection system 1 for the first time prior to the next processing step, and there an optical image (of the wafer edge, in this exemplifying embodiment) is acquired. The usual processing of the wafer then occurs, by application of resist to the wafer; curing of the resist; edge bead removal (EBR), usually by wet-chemical EBR and then, depending on the production process, by optical EBR (OEBR); then exposure of the photoresist in the stepper; and lastly development of the photoresist layer to form the desired relief on the wafer surface. Further steps (implantation, evaporative deposition of metal layers, etc.) can follow, in which context the wafer usually passes through the aforesaid processing steps several times. An examination of edge bead removal occurs in each cycle, according to the present invention, prior to application of the photoresist layer and after edge bead removal, i.e. advantageously after development of the photoresist layer.

The processed wafer is accordingly conveyed a second time, usefully after development of the photoresist layer, to inspection system 1 in order to acquire a second optical image of the wafer edge. If the wafer is recoated with resist immediately thereafter, this acquired image can serve once again as the first image in the next processing cycle.

The image data of the first and the second image are conveyed via data line 16 to data readout device 17 having computer unit 18. There a comparison is made of the first and the second image by image processing; in this exemplifying embodiment, the width of the edge bead removal at wafer edge 23 is to be represented as accurately as possible. The comparison according to the present invention of the images is accomplished most easily by differentiation, in which context a weighting of the image data of the first and second images may be advisable.

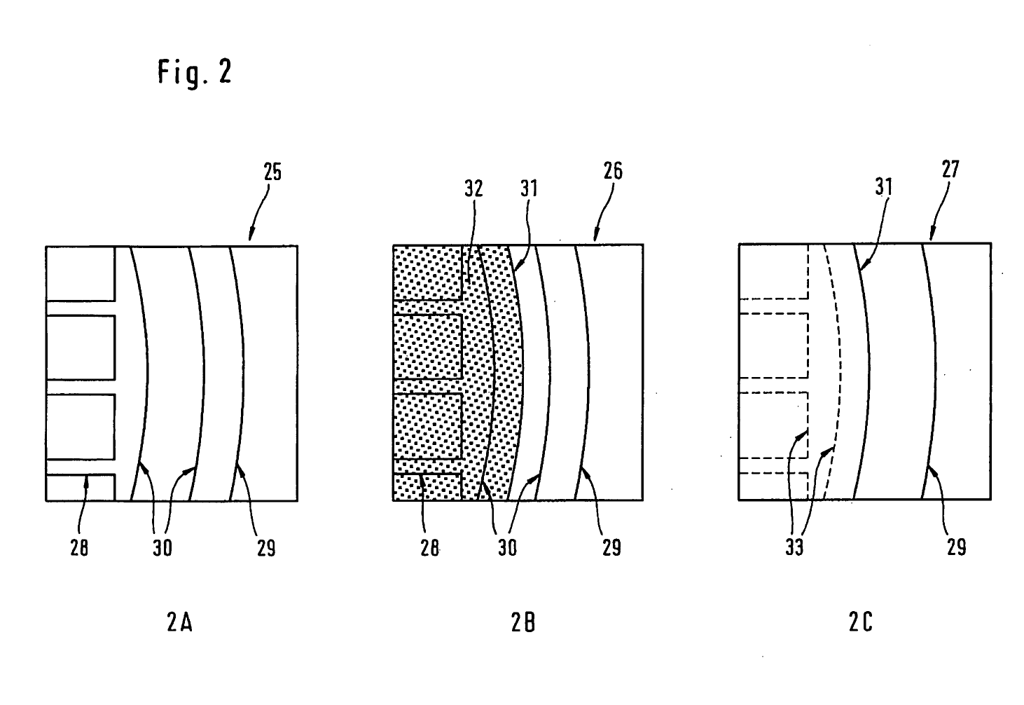

FIG. 2 schematically shows a first optical image 25 and a second optical image 26 that are typically acquired when examining edge bead removal using, for example, a matrix camera in the above-described system 1. FIG. 2C shows a comparison image 27 that reproduces the differences between the first and the second image.

First optical image 25 (FIG. 2A) shows structures 28 from previous process steps on the wafer surface, edges 30 from previous process steps, and wafer edge 29. Second optical image 26 (FIG. 2B) shows the image of the same region to be inspected, after application of a photoresist layer and after edge bead removal (EBR). The region covered with resist is labeled 32, and the resist edge after EBR is labeled 31. As is evident from FIG. 2B, this second optical image 26 exhibits structures that derive from the previous process steps, namely structures 28 and 30. These structures make automatic inspection of EBR difficult and, in some cases, impossible. It has been found that these interfering structures can be eliminated according to the present invention by the fact that a first image 25 of the region to be examined is acquired prior to application of the photoresist layer, and is then, so to speak, subtracted from second optical image 26. As is apparent from FIG. 2C, the structures to be inspected become clearly evident in comparison image 27. Resist edge 31 subsequent to the most recently performed EBR is clearly visible, while the structures from previous process steps, labeled 28 and 30 in FIG. 2A, recede considerably. The regions whose appearance has been modified by the superimposed resist are labeled 33 in FIG. 2C. The comparison image permits an accurate measurement of EBR, for example, by pattern recognition, with which the width of the bead-removed edge, tolerance limits, and other variables of interest can be derived.

The invention presented here makes possible rapid throughput of examined wafers within their production process with a minimal space requirement. Instead of imaging device 9 described above, X/Y scans or one-shots (images of the entire wafer) can also be used.

The best results for examination of edge bead removal have been obtained with an incident bright-field illumination, the use of color images being advantageous. Either a color camera is needed for this, or illumination occurs sequentially at different wavelengths.

Possible radiation sources are, among others, fiber illumination, LEDs, fluorescent lamps, halogen lamps, metal vapor lamps, flash lamps, or lasers. The spectrum of the radiation can be polychromatic or monochromatic. The spectral range can also lie, depending on the sensitivity of imaging device 9, in the visual, infrared, or even UV region. Photodiodes or linear or matrix cameras, which in turn can be configured as monochromatic or color cameras, e.g. in the form of CCD or CMOS cameras, are suitable as optical detector 9.

For optimum management of the data sets in data readout unit 17, it may be useful to store only the results of the inspection and to discard the actual image data. If no results are to be calculated with the available images, or if the tolerances to be complied with are exceeded, in individual cases the various optical images can be stored for subsequent visual examination.

Further exemplifying embodiments will be presented below; it should be noted in this context that the statements made above regarding the types of radiation sources, optical detectors, and illumination to be used are also valid for the exemplifying embodiments below. What will be addressed in particular below, therefore, are differences between the exemplifying embodiments below and the one discussed above.

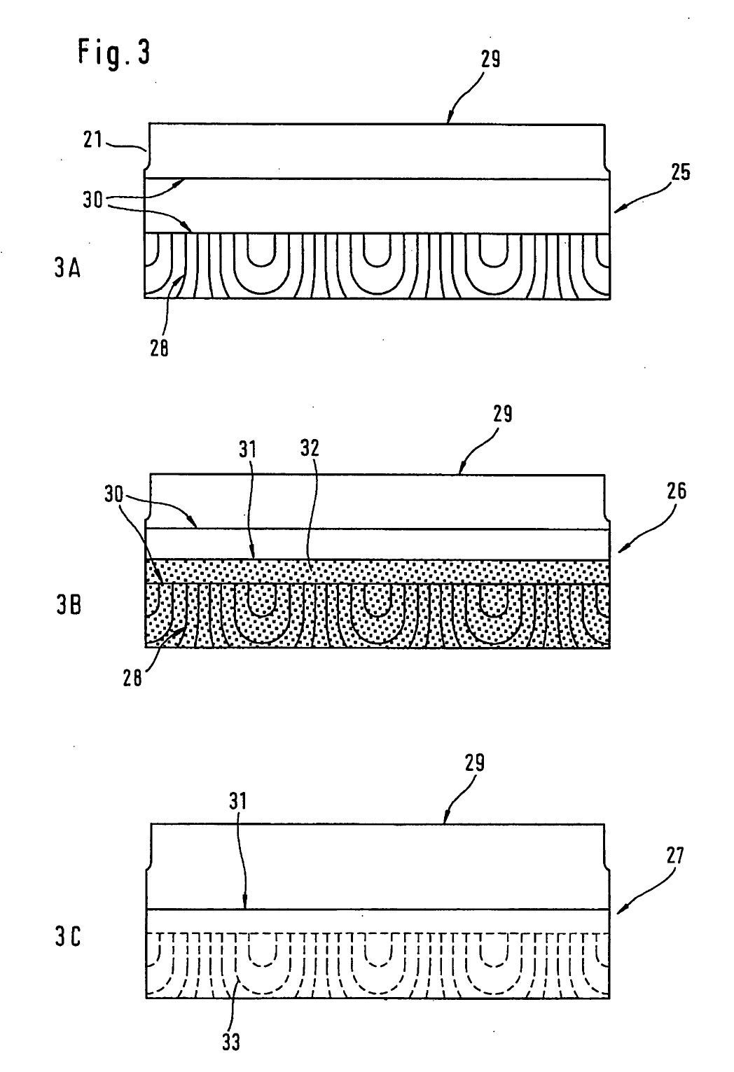

FIG. 3 schematically shows two optical images (FIGS. 3A and 3B) such as might be acquired, for example, using a linear camera in a system according to FIG. 1, as well as a comparison image (FIG. 3C).

Optical images 25 and 26 can be acquired, for example, in a system such as the one depicted in FIG. 1, in which wafer 2 rotates beneath a linear camera constituting optical detector 9, the imaging axis of optical detector 9 preferably being perpendicular to wafer 2. With this rotational scan, what is obtained as image 25 is an unrolled edge image of the structures depicted in FIG. 2A.

First optical image 25 (FIG. 3A) shows structures 28 from previous process steps on the wafer surface, as well as edges 30 from previous process steps. The wafer edge is labeled 29. The unrolled edge depiction begins here at a marking, referred to as a notch or flat 21, that is usually applied to a wafer for orientation and calibration purposes.

Second optical image 26 (FIG. 3B) shows an image of the same region to be inspected, after application of a photoresist layer and after edge bead removal (EBR). The region covered with resist is labeled 32. After wet-chemical and/or optical EBR, resist edge 31 is present in the region to be inspected of the wafer. As is evident from FIG. 3B, second optical image 26 exhibits structures that derive from the previous process steps, namely structures 28 and 30. Automatic inspection of EBR on the basis of an optical image 26 of the region to be inspected was hitherto almost impossible because of these structures. According to the present invention, images 25 and 26 are therefore subjected to a comparison, image processing procedures preferably being employed for that purpose. The intention is that in this comparison, structures occurring in both images 25 and 26 are to be suppressed as much as possible, whereas newly added structures are to be emphasized. In the simplest case, the comparison can be made by creating a difference between images 26 and 25.

A comparison image 27 is depicted in FIG. 3C. Regions 33 whose appearance has been modified by superimposed resist are visible in attenuated fashion. In particular, edges 30 from previous process steps are (almost) eliminated, and structures 28 from previous process steps are greatly weakened. Resist edge 31 becomes clearly apparent with reference to wafer edge. It is of course important to ensure, when producing comparison image 27, that wafer edge 29 is maintained as the reference line. The EBR width can now be measured accurately with reference to comparison image 27. In particular, accurate measurement of EBR can be automated by means of a pattern recognition method.

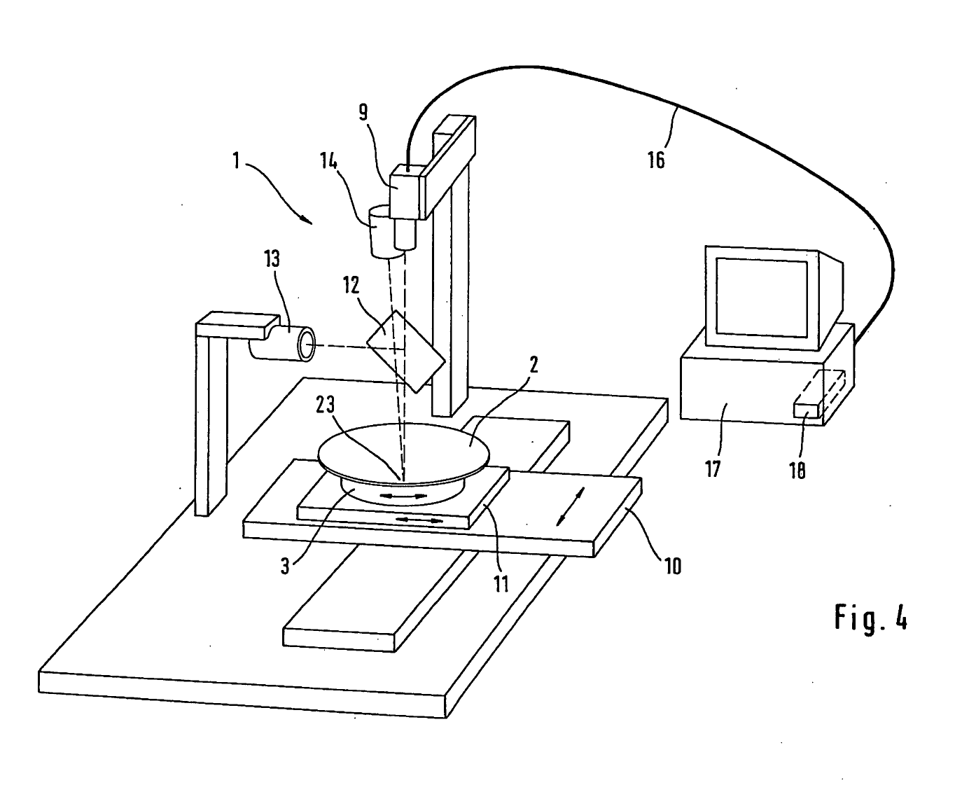

Further alternatives to the wafer inspection system depicted in FIG. 1 are depicted in FIGS. 4 through 7.

FIG. 4 shows a wafer inspection system 1 having a configuration similar to the system of FIG. 1. Identical elements are designated by identical reference characters. Wafer 2 is received by a receiving device 3 that permits a rotation of wafer 2 about its center. Receiving device 3 is connected to a X scanning stage 11 and a Y scanning stage 10. The combination of rotatable device 3 and scanning stages 10 and 11 on the one hand makes possible alignment of region 23 to be inspected on wafer 2, and on the other hand allows for a variety of imaging methods, such as X-Y scanning, the unrolled edge image (rotational scan) already discussed, but also a one-shot, using a matrix camera, of region 23 to be inspected.

In contrast to the system of FIG. 1, a bright-field illumination device 13 is arranged with its axis (drawn with a dashed line) parallel to the surface of wafer disk 2. By means of a beam splitter 12 (for example, a semitransparent mirror), the light of bright-field illumination device 13 is deflected so as to be incident perpendicularly onto region 23 to be inspected. Optical detector 9 is now arranged with its imaging axis (also drawn with a dashed line) perpendicularly above region 23 to be inspected.

In addition to bright-field illumination device 13, which can correspond to incident illumination device 5 depicted in FIG. 1, a dark-field illumination device 14 is provided in system 1 shown in FIG. 4. This device as well can be configured, in principle, like incident illumination device 5 of FIG. 1. It should be noted, however, that the axis (drawn with a dashed line) of dark-field illumination device 14 does not extend parallel to the imaging axis of optical detector 9, but instead is inclined with respect thereto. This inclination ensures observation in dark-field mode, in which only radiation refracted or scattered at structures to be examined in region 23 of wafer 2 strikes the imaging surface of optical detector 9.

With wafer inspection system 1 depicted in FIG. 4 it is possible to work both in bright-field and in dark-field mode and also in a combined bright- and dark-field mode, depending on which of bright-field and dark-field illumination devices 13 and 14 are put into operation. Regarding the advantages of the different observation modes, reference is made to the statements above especially in connection with the system according to FIG. 1.

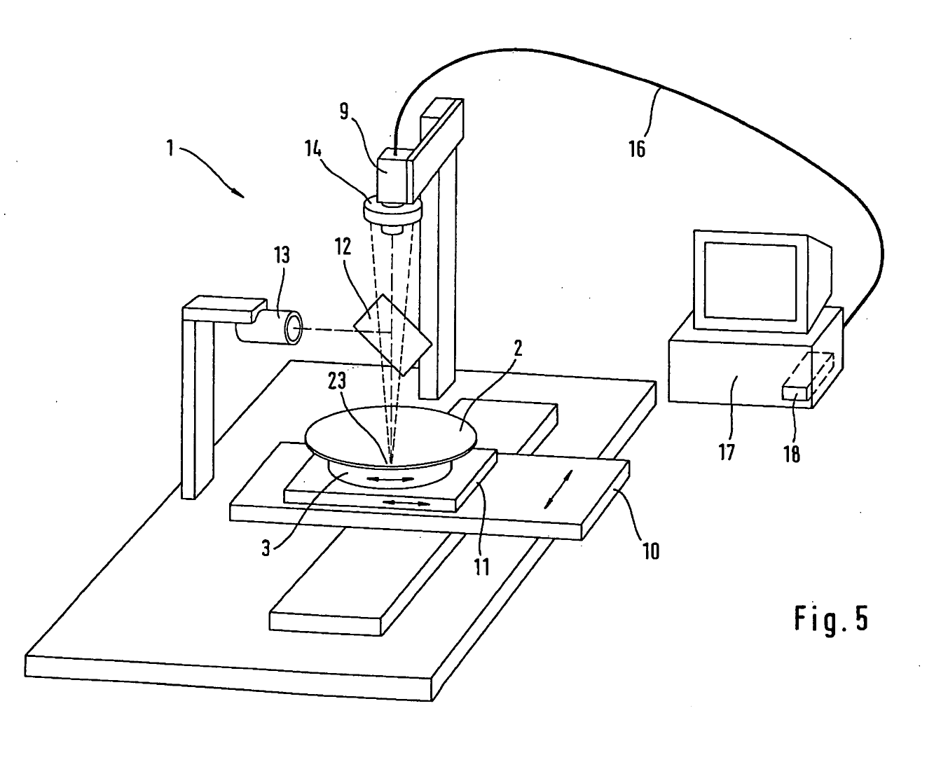

FIG. 5 substantially shows wafer inspection system 1 of FIG. 4 with a modified dark-field illumination device 14. Otherwise all the statements already made with regard to system 1 of FIG. 4 are also valid in the present instance. Only the differing configuration of dark-field illumination device 14 will be discussed below.

Dark-field illumination device 14 in FIG. 5 is, for example, a light source having a collimating lens system placed in front. This arrangement ensures that only radiation from the cone (drawn with dashed lines) of dark-field illumination device 14 strikes region 23 to be inspected on wafer 2. The fact that optical detector 9 is arranged at the center of illumination device 14 ensures dark-field observation. Once again, bright-field observation can additionally be performed by putting bright-field illumination device 13 into operation.

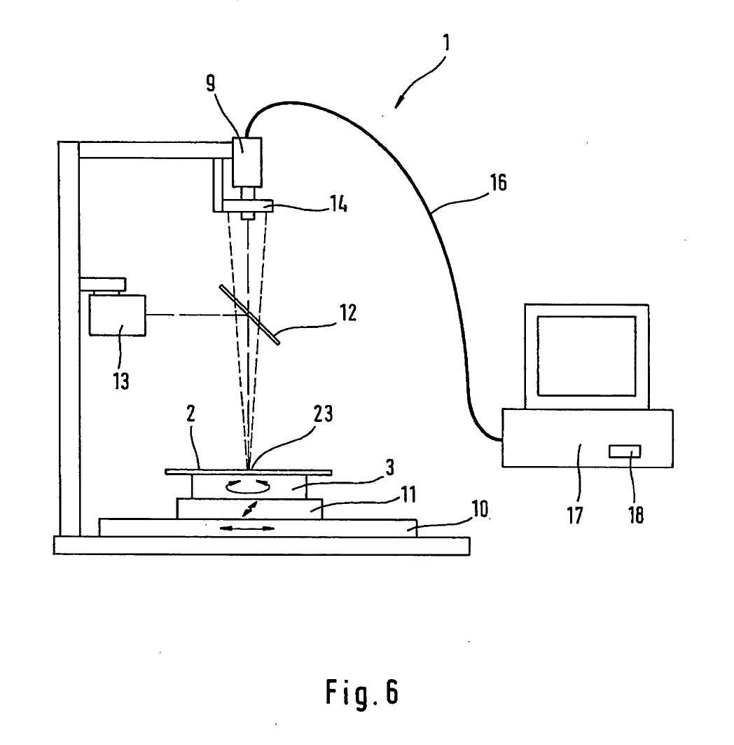

FIG. 6 depicts system 1 of FIG. 5 again, in a different view (from the side). As a result, the beam path of dark-field illumination device 14, represented by the cone and imaging axis (both drawn with dashed lines) of optical detector 9, is clearly recognizable.

In system 1 according to FIG. 6, the bright-field illumination device is mounted not separately, but instead on the attachment device for optical detector 9 and dark-field illumination device 14. The position of beam splitter 12 is adapted accordingly.

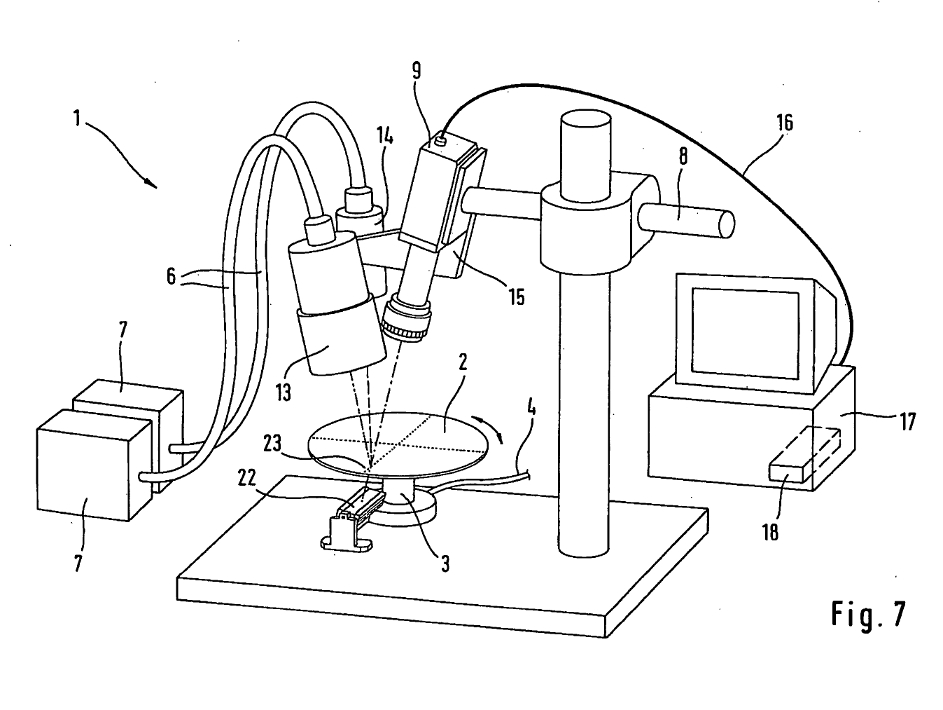

Lastly, FIG. 7 shows a further embodiment of system 1 according to FIG. 1. What is depicted here is an embodiment of system 1 of FIG. 1 having an additional dark-field illumination device 14 that enables combined observation in bright-field and dark-field mode. For that purpose, incident illumination device 5 of system 1 of FIG. 1 is used here as bright-field illumination device 13. In principle, illumination devices 13 and 14 can be the same kind of illumination device (with light-guiding bundle 6 and light source 7), but different illumination device types are also possible. In the context of combined bright- and dark-field observation, the wafer normal line, the illumination axis of bright-field illumination device 13, and the imaging axis of optical detector 9 lie in a common plane; the illumination axis of dark-field illumination device 14 does not lie in that plane, and is aligned in such a way that it intersects that plane in region 23 to be inspected on wafer 2.

Regarding the advantages of combined bright- and dark-field observation, reference is made once again to the statements above. The particular concrete configuration that is selected depends principally on the structures being examined and the quality of the resulting images and the comparison image.

It should be noted once again that the individual components of the systems shown in FIGS. 1 and 4 through 7, in particular the illumination devices and the wafer receiving devices and scanning stages, can be combined into further system configurations without leaving the range of protection of the invention.

### Parts List

1 System for wafer inspection
2 Wafer
3 Receiving device
4 Vacuum line
5 Incident illumination device
6 Light-guiding bundle
7 Light source
8 Support element
9 Optical detector, imaging device
10 Y-scanning stage
11 X-scanning stage
12 Beam splitter
13 Bright-field illumination device
14 Dark-field illumination device
15 Support rail
16 Data line
17 Data readout device, computer
18 Computer unit
21 Notch, flat
22 Wafer edge position detection device
23 Edge region, region to be inspected of wafer
25 First optical image
26 Second optical image
27 Comparison image
28 Structures from previous process steps
29 Wafer edge
30 Edges from previous process steps
31 Resist edge after edge bead removal
32 Region covered with resist
33 Regions whose appearance has been modified by superimposed resist

1. A method for inspecting a wafer, comprising:
acquiring, prior to an application of a layer onto the wafer, a first optical image of a region of the wafer surface to be inspected;
acquiring, after an at least partial removal of the layer, a second optical image; and
inspecting the region of the wafer surface by comparing the first and the second images.

2. The method as recited in claim 1 wherein the inspecting includes examining edge bead removal.

3. The method as recited in claim 1 wherein the layer is a photoresist layer.

4. The method as recited in claim 3 wherein the at least partial removal of the layer includes removal at least in an edge region of the wafer.

5. The method as recited in claim 1 wherein the acquiring the second optical image is performed after a developing of the photoresist layer.

6. The method as recited in claim 1 wherein the layer is an antireflection layer.

7. The method as recited in claim 1 wherein the comparing includes a differentiation of the first and second images.

8. The method as recited in claim 1 wherein at least one of the acquiring the first optical image and the acquiring the second optical image is performed in at least one of bright-field mode, dark-field mode, and combined bright-field and dark-field mode.

9. The method as recited in claim 1 wherein the at least one of the acquiring the first image and the acquiring the second image is performed by scanning using an optical detector.

10. The method as recited in claim 1 further comprising polychromatically illuminating the region of the wafer surface.

11. The method as recited in claim 1 further comprising monochromatically illuminating the region of the wafer surface.

12. A wafer inspection system for inspecting a wafer, comprising:
an optical detector configured to acquire a first and a second optical image of a region of the wafer to be inspected;
a data readout device configured to read out data of the first and second optical images acquired by the optical detector;
a computer unit connected to the data readout device and configured to compare the acquired first and second images of the region to be inspected.

13. The wafer inspection system as recited in claim 12 wherein the computer unit is configured to compare the acquired first and second images of the region to be inspected so as to examine edge bead removal.

14. The wafer inspection system as recited in claim 12 wherein the optical detector is capable of being integrated into a process of manufacturing the wafer.

15. The wafer inspection system as recited in claim 12 wherein the optical detector includes a linear detector.

16. The wafer inspection system as recited in claim 12 wherein the optical detector includes a planar detector.

17. A computer readable medium having stored thereon computer executable process steps operative to perform a method for inspecting a wafer, the method comprising:
acquiring, prior to an application of a layer onto the wafer, a first optical image of a region of the wafer surface to be inspected;
acquiring, after an at least partial removal of the layer, a second optical image; and
inspecting the region of the wafer surface by comparing the first and the second images.

18. The computer readable medium as recited in claim 17 wherein the comparing is performed using a computer unit connected to a data readout device, the computer executable process steps being executable on the computer unit.

19. The computer readable medium as recited in claim 17 wherein the inspecting includes examining edge bead removal.

20. The computer readable medium as recited in claim 17 wherein the layer is a photoresist layer.
